(19) United States
(12) Patent Application Publication
(10) Pub. No.: US 2020/0340447 A1
(43) Pub. Date: Oct. 29, 2020

(54) METHOD FOR CONTROLLING AND BRAKING WIND TURBINE BASED ON INDIVIDUAL PITCH CONTROL

(71) Applicant: DALIAN UNIVERSITY OF TECHNOLOGY, Dalian, Liaoning (CN)

(72) Inventors: Zhiyu JIANG, Dalian, Liaoning (CN); Zhengru REN, Dalian, Liaoning (CN); Wei SHI, Dalian, Liaoning (CN); Dezhi NING, Dalian, Liaoning (CN)

(21) Appl. No.: 16/762,045

(22) PCT Filed: Aug. 22, 2018
(86) PCT No.: PCT/CN2018/101650

§ 371 Date: May 6, 2020

(30) Foreign Application Priority Data
Aug. 6, 2018 (CN) 201810884863.8

(51) Int. Cl. F03D 7/02

(52) U.S. Cl. CPC F03D 7/0244; F03D 7/0224

(57) ABSTRACT

A method for aerodynamic braking based on the independent pitch for horizontal-axis wind turbines is disclosed. The pitch angle of each blade is increased by the pitch driver installed on each blade while a wind turbine adopts pitch-to-feather braking. In accordance with the change rate of the pitch angle of each blade, the pitch angle of each blade is adjusted, respectively. Strain sensors are installed at the root of each blade, sensors used for the blade pitch measurement are installed on the inner edge of the hubs, and the pitch actuators and controllers are installed in the nacelle of the wind turbine. The respective magnitude of the tensile force is measured by the strain sensors at the roots of the three blades, and the resultant change rate is calculated. At different time instants, the pitch angle is increased to its maximum 90 degrees by using the pitch actuator.

### THE FIELD OF THE INVENTION

The present invention, belonging to the technical field of wind energy, relates to a method for controlling and braking wind turbine based on individual pitch control.

### BACKGROUND

According to the direction of the rotor main shaft, the wind turbine can be divided into horizontal-axis wind turbine and vertical-axis wind turbine. Up to now, most onshore and offshore wind farms consist of horizontal-axis wind turbine. In accordance with the control methods, horizontal-axis turbines can be divided into stall-regulated wind turbines and pitch-regulated wind turbines. The stall ones have fixed pitch angles and are primarily kilowatt-sized wind turbines in early times. Megawatt-sized wind turbines have variable pitch and variable speed in order to achieve the power efficiency.

The structural design of the horizontal-axis wind turbines needs to meet the ultimate and the fatigue load check considering a set of load cases. The international design standards specify load cases related to normal operation, idling (parked) condition, and shutdown conditions. For pitch-regulated wind turbine, the shutdown condition means that three blades of the wind turbine shall be increased to its maximum pitch angle (90 degree) collectively in a short time. In this process, the rotor is stopped due to a sudden increase in the pitch angle and a reversion of the torque direction due to the aerodynamic forces on the blades.

There are several causes for wind turbine shutdown. High wind speed can be one cause. Wind turbine need to shut down to avoid overloading. Faults occurring at key parts of the wind turbine can be another cause. During the braking process, a large impact load be imposed on the main shaft by the sudden increase of the pitch angle of the blades. Moreover, because of the turbulent wind, the local inflow wind speed of the three blades are not the same, thus leading to uneven stress and imbalanced bending moment on the blades. This phenomenon often leads to structural fatigue damages of the main bearings and increased maintenance costs for wind turbine operators.

### SUMMARY

The objective of the present invention is to provide a method for reducing the imbalanced loads on the root of the blade during the braking process of the wind turbine. Thus, the reliability of the wind turbines can be improved while the maintenance costs are reduced.

A braking method based on the individual pitch control for wind turbines. The steps are as comprises the following steps: when a wind turbine adopts pitch braking, the pitch angle of each blade is increased by the pitch actuator installed on each blade. Because of individual pitch control system, the pitch angle of each blade in the wind turbine has different change rate. The pitch angle of each blade is adjusted in accordance with its change rate.

Strain sensors are installed at the root of each blade, sensors used for the blade pitch measurement are installed on the inner edge of the hubs, and the pitch actuators and controllers are installed in the nacelle of the wind turbine.

The respective magnitude of the tensile force is measured by the strain sensors lying on the roots of the three blades, and the response change rate is calculated.

As for the k^{th} blade, the relation between the response change rate and tensile stress of its pitch angle is as follow:

$${\dot{θ}}_{k} = f ( {σ}_{1} , {σ}_{2} , {σ}_{3} ) = min \{ \frac{\sqrt{{σ}_{1}^{2} + {σ}_{2}^{2} + {σ}_{3}^{2}}}{μ \cdot {σ}_{k}} , {\dot{θ}}_{max} \}$$

In this formula, \dot{θ}ₖ is the change rate of the pitch angle of blade k, k=1, 2, 3; σ₁, σ₂, σ₃ is the tensile stress at the root of the blade 1, 2 and 3 at some moment; μ is the coefficient, which is determined by numerical simulation. From the equation, blade k should maintain a smaller pitch angle change rate when the tensile stress is too great. Conversely, a larger pitch angle response change rate should be adopted. However, the response change rate of the pitch angle should not exceed the limit—\dot{θ}ₘₐₓ of the pitch actuator system. At different points of time, the pitch angle of each blade is increased to its maximum—90 degree by the pitch actuator. When the rotor speed is lower than 1 rpm, the braking process of the wind turbine is finished and the pitch angle no longer changes.

The wind turbine is a horizontal-axis pitch-regulated wind turbine, onshore or offshore.

The beneficial effects of the present invention:

(1) The component parts of the present apparatus: the stress strain gauge, the sensors and the pitch actuators are off-the-shelf industrial products.

(2) The impact load caused by the imbalanced loads during braking is reduced, which could also extend the life of the main shaft and main bearing of the wind turbine.

(3) The reliability of the wind turbine is improved while the maintenance costs can be reduced.

### BRIEF DESCRIPTION OF THE DRAWINGS

FIG. 1 is a schematic diagram of the onshore three-bladed horizontal-axis wind turbine.

FIG. 2 (a) is a schematic diagram of the pitch position of the blade on the top of the wind turbine before braking.

FIG. 2 (b) is a schematic diagram of the pitch position of the blade on the top of the wind turbine after braking.

FIG. 3 (a) shows the collective pitch braking and the variation of the pitch angle of the wind turbine during braking.

FIG. 3 (b) shows the individual pitch control braking and the variation of the pitch angle of the wind turbine during braking.

FIG. 4 (a) shows conventional collective pitch braking and variation of the imbalanced loading moment inside the rotor disk of the wind turbine when braking.

FIG. 4 (b) shows individual pitch control braking and a variation of the unbalanced loading moment inside the disk of the wind turbine in the braking process.

FIG. 5 is the controller block diagram of the individual pitch control applied to the barking process of wind turbines.

FIG. 6 is the flowchart of the braking process of the present invention.

In the figures: 1 blade, 2 strain sensors, 3 seabed, 4 blade profile, 5 rotor plane.

### DETAILED DESCRIPTION

Hereinafter, the present invention is further explained in combination with the drawings and specific embodiment.

A braking method for the individual pitch-controlled wind turbine comprises the steps as follows: when the wind turbine adopts pitch braking, the pitch angle of each blade is increased by the pitch actuator installed on each blade. Because of individual pitch control system, the pitch angle of each blade in the wind turbine has different change rate. The pitch angle of each blade is adjusted in accordance with its change rate;

Strain sensors are installed at the root of each blade. Sensors used for the blade pitch measurement are installed on the inner edge of the hubs, and the pitch actuators and controllers are installed in the nacelle of the wind turbine.

The respective magnitude of the tensile force is measured by the strain sensors lying on the roots of the three blades, and the response change rate is calculated.

As for the k^{th} blade, the relation between the response change rate and tensile stress of its pitch angle is as follow:

$${\dot{θ}}_{k} = f ( {σ}_{1} , {σ}_{2} , {σ}_{3} ) = min \{ \frac{\sqrt{{σ}_{1}^{2} + {σ}_{2}^{2} + {σ}_{3}^{2}}}{μ \cdot {σ}_{k}} , {\dot{θ}}_{max} \}$$

In this formula, \dot{θ}ₖ is the response change rate of the pitch angle of blade k, k=1, 2, 3; σ₁, σ₂, σ₃ is the tensile stress at the root of the blade 1, 2 and 3 at some moment; μ is the coefficient, which is determined by numerical simulation. From the equation, blade k should maintain a smaller pitch angle response change rate when the tensile stress is too great. Conversely, a larger itch angle response change rate should be adopted. However, the response change rate of the pitch angle should not exceed the limit—\dot{θ}ₘₐₓ of the pitch actuator system. At different times, the pitch angle of each blade is increased to its maximum—90 degree by the pitch actuator. When the rotor speed is lower than 1 rpm, the braking process of the wind turbine is finished and the pitch angle no longer changes.

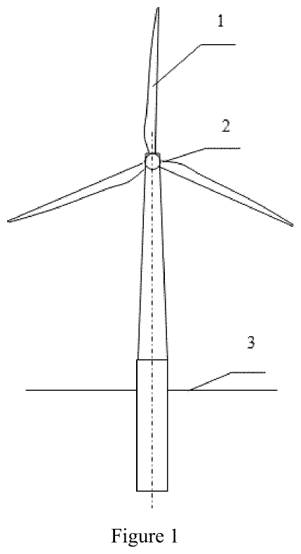

FIG. 1 is a 6 MW wind turbine, with a 10-meter-long nacelle and a weight of 360 tons, the height of the nacelle is 100 meters above the ground. In order to measure the tensile stress and to calculate the moment loads on blades while braking, strain sensors are installed at the root of each blade.

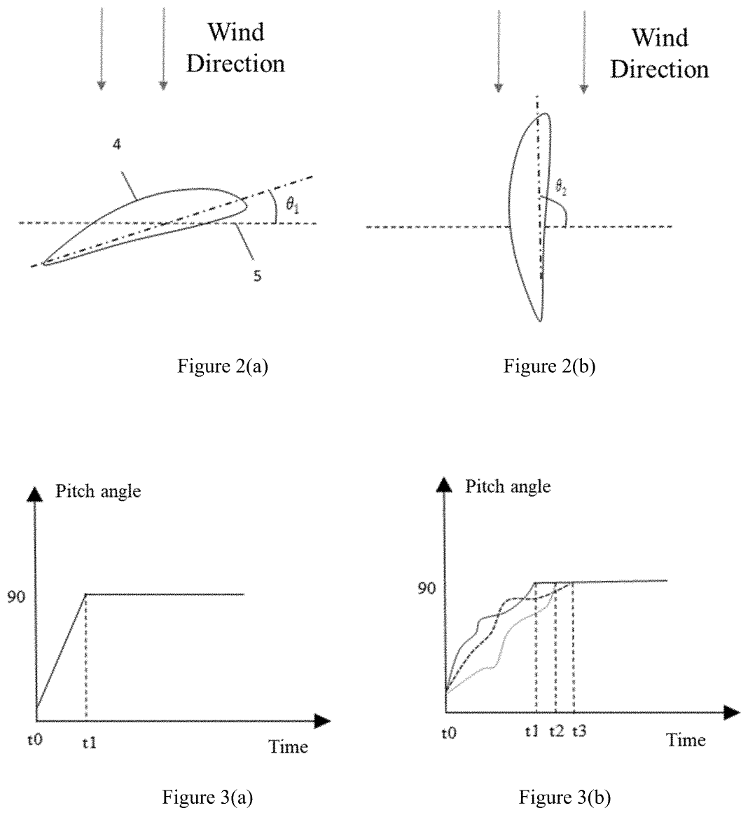

FIG. 2 is the position of some blade at the beginning and the end of braking. The initial pitch angle of the blade θ₁=15 degrees. The angle increased continually to θ₂ =90 degrees under the effect of pitch actuator. In this process, blade stops gradually due to the aerodynamic torque.

FIG. 3 shows the changes of pitch angle of the three blades in the braking process. On the left, it shows a normal braking mode, the three blades are collectively pitch controlled. The pitch angle is increased to 90 degrees at t₀ moment. At the moment of t₁, the braking is finished. On the right, it shows an individual pitch control braking. The three blades reach the largest angle at the instants of t₁, t₂ and t₃ because of individual control and different variation routes.

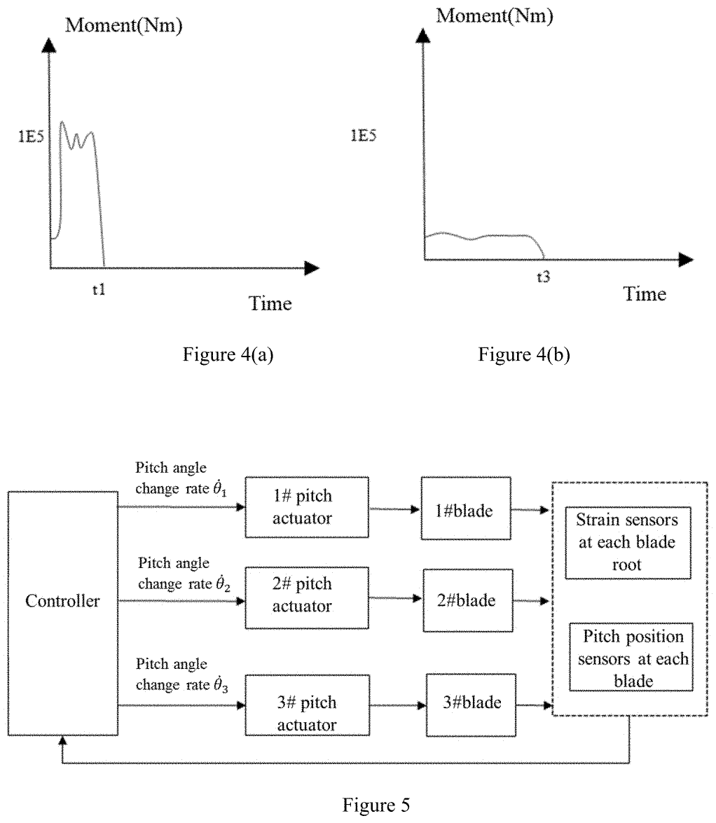

FIG. 4 is the schematic diagram of changes of imbalanced loads, which is destructive to wind turbine. While adopting the normal braking (see left), the bending moment remains at a relatively high level after braking due to the imbalanced aerodynamic loads on the three blades until finished. While adopting the individual pitch control braking, a relatively low imbalanced loads is ensured due to the balanced forces by adjusting the pitch angles of the three blades.

FIG. 5 is the block diagram of the individual pitch control system. As shown in the diagram, one of the key is to calculate the change rate of the pitch angle of each blade by using the measurement of strain sensor at the root, and to adjust the angle changes by individual pitch control actuators on each blade.

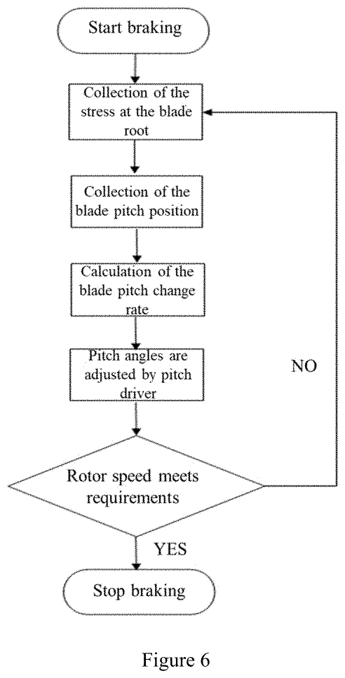

FIG. 6 is the flowchart of overall system of the individual pitch control system in the braking process. As the wind speed and blade speed changes, the aerodynamic loads on each blade varies. In accordance with the data signals collected by the strain at the root of the blade, the change rate of the pitch at the next moment is calculated. Pitch angles are adjusted continuously by pitch driver to meet the requirement of the blade.

1. A braking method based on the individual pitch control for wind turbines, when a wind turbine adopts pitch braking, the pitch angle of each blade is increased by the pitch actuator installed on each blade; because of the individual pitch control system, the pitch angle of each blade in the wind turbine has different change rate; the pitch angle of each blade is adjusted in accordance with its change rate; wherein the steps are as follows:
strain sensors are installed at the root of each blade, sensors used for the blade pitch measurement are installed on the inner edge of the hubs, and the pitch actuators and controllers are installed in the nacelle of the wind turbine;
the respective magnitude of the tensile force is measured by the strain sensors lying on the roots of the three blades, and the resultant change rate is calculated;
as for the k^{th} blade, the relation between the change rate and tensile stress of its pitch angle is as follows:
$${\dot{θ}}_{k} = f ( {σ}_{1} , {σ}_{2} , {σ}_{3} ) = min \{ \frac{\sqrt{{σ}_{1}^{2} + {σ}_{2}^{2} + {σ}_{3}^{2}}}{μ \cdot {σ}_{k}} , {\dot{θ}}_{max} \}$$
where \dot{θ}ₖ is the change rate of the pitch angle of blade k, k=1, 2, 3; σ₁, σ₂, σ₃ is the tensile stress at the root of the blade 1, 2 and 3 at some moment; μ is the coefficient, which is determined by numerical simulation; from the equation, blade k should maintain a smaller pitch change rate when the tensile stress is too great; conversely, a larger pitch change rate should be adopted; however, the change rate of the pitch angle should not exceed the limit \dot{θ}ₘₐₓ of the pitch actuator; at different time, the pitch angle of each blade is increased to its maximum 90 degree by the pitch actuator; when the rotor speed is slower than 1 rpm, the braking process of the wind turbine is finished and the pitch angle no longer changes.
